(19) United States
(12) Patent Application Publication
(10) Pub. No.: US 2002/0182470 A1
(43) Pub. Date: Dec. 5, 2002

(54) Injection molded fuel cell endplate

(76) Inventors: Ami Ei Agizy, Basking Ridge, NJ (US); David M. Sheridan, Troy, MI (US); Richard G. Hanson, Whalen, MN (US)

Correspondence Address: TICONA LLC, 86 MORRIS AVENUE, SUMMIT, NJ, 07901, US

(21) Appl. No.: 09/827,904

(22) Filed: Apr. 6, 2001

(51) Int. Cl. H01M 8/02

(52) U.S. Cl. 429/34; 429/37

(57) ABSTRACT

Molded fuel cell endplate fabricated from a long fiber reinforced thermoplastic resin composite, which composite comprises:

(a) a thermoplastic resin; and

(b) at least about 30 weight percent of long strand glass fiber having a fiber length of at least about 5 mm.

### BACKGROUND OF THE INVENTION

1. Field of the Invention

This invention relates to fuel cell endplates fabricated from a thermoplastic resin composite.

2. Description of the Prior Art

The interest in alternative energy supply mechanisms has focused much attention on fuel cells as a potential source of clean, low-cost power for a variety of end-use applications. A fuel cell is an electrochemical energy conversion device that produces electricity and heat by the reaction of fuel, e.g., hydrogen rich reformate, and an oxidant gas. Numerous variations exist on the design and configuration of particular fuel cell systems, however, an integral part of most systems is a fuel cell stack comprised of a series of membrane electrode assemblies separated from one another by bipolar collector plates wherein the stack terminates at both ends with an endplate assembly comprising an endplate and, in typical designs to date, a compression plate. The stack is also provided with fuel and oxidant gas supply and removal means, as well as a means of circulating coolant through the stack. Connecting means, for example, tie rods or bands, hold the stack together and, in conjunction with the endplate assemblies, exert a compressive force on the stack, which assists in sealing the entire fuel cell stack assembly.

The force exerted on the fuel cell stack can be great and depends, in part, on factors that include the stack height and cross-sectional area as well as the gasket material used in the stack. To avoid stack failure and maximize electric efficiency, the endplate assemblies must be strong enough to withstand the force exerted on the stack without breaking or warping. Typically, the endplate assembly also needs to withstand use temperatures of up to 70° C. or higher. Additionally, when the endplate functions as the manifold through which coolant, fuel, and oxidant gas are introduced and removed from the stack, the endplate may need to withstand contact with such materials without deteriorating or corroding.

Commonly, the compression plates and endplates contained in the endplate assemblies are fabricated from metal. In addition to being relatively high in cost and susceptible to corrosion, metal plates can add substantially to the weight of a fuel cell stack. In automotive and other applications it is generally desirable to minimize the size and weight of the fuel cell stack. The use of plastic materials in the fabrication of lighter weight endplates has been suggested. For example, U.S. Pat. No. 6,048,635 discloses an endplate assembly comprising a header fabricated from a reinforced polymeric material mounted on a metal end plate. The polymeric material is described as preferably containing at least 30% of glass fiber. At column 3, line 65 to column 4, line 1, the patent further states that the header is “. . . preferably fabricated from a polymeric material such as NORYL, a proprietary product of General Electric Company.” General Electric Company markets modified polyphenylene oxide resins under the NORYL trademark.

Other uses of plastic materials in fuel cell end plate assemblies are disclosed in the prior art. For example, WO 00/36682 discloses the use of layered manifold assemblies as fuel cell endplates. In the Example provided, the use of manifold assemblies made of glass filled thermoplastic layers bonded together with glue is disclosed. U.S. Pat. No. 5,629,104 discloses a modular energy device for combining fuel cells. At column 2, lines 24 to 27 the device is described as including “a pair of injection molded hard plastic end plates, a plurality of hard plastic bi-plates, and at least two side plates all interconnected via a snap and lock mechanism.” At column 4, line 67 to column 5, line 1, the patent notes “any plastic or plastic composite material capable of being injection molded may be suitable for the end plates”.

WO 99/27601 discloses fuel cell biplates and endplates made of polymeric materials. The patent application lists as “useful polymeric materials” the following: “polyolefine such as high density polyethylene, and polypropylene; polyamide plastics; polycarbonates; polyesters including poly(ethylene terephthalate), and poly(butylene terephthalate; polyethers; phenolic resins; and polystyrenes including acrylonotrile-butadiene-styrene (ABS).” The disclosure goes on to note that “If the need for further structural strength arises, the thermoplastics materials can be reinforced with fibers such as carbon or Kevlar . . . ” See page 16, line 21 to page 17, line 5.”

German Application Publication No. 197 49 003 A1 discloses a low temperature fuel cell with at least one connecting element and/or at least one end plate which, except for a metallic gas distributor structure and a metallic electrical connection, consists of plastic. The application discloses Teflon™ PTFE or polysulfone as suitable plastics for such applications.

While plastic endplates were acknowledged in the art as having potential property advantages over conventional metal end plates, plastic materials can have widely variable properties. Prior to this invention, there remained a need for a plastic fuel cell endplate having strength and dimensional stability at relatively thin dimensions, which endplate was capable of being relatively easily produced A fuel cell endplate that was resistant to corrosion by fuel, oxidant gas and coolant with which it was in contact was also desired, as was an endplate assembly which did not contain metal plates.

### SUMMARY OF THE INVENTION

In one embodiment, the present invention is directed to a molded fuel cell endplate fabricated from a long fiber reinforced thermoplastic resin composite, which composite comprises:

a) a thermoplastic resin; and

b) at least about 30 weight percent of long strand glass fiber at least about 5 mm in length.

In another embodiment, the present invention relates to an endplate assembly comprising such an endplate.

### DESCRIPTION OF THE DRAWINGS

FIG. 1 is a schematic of a fuel cell stack having endplates 10, and, to collect and conduct current, bus plates 14 at either end of the stack. The stack is equipped with means to remove supply and remove coolant, oxidant gas and fuel, shown as distribution means 20, 22 and 24, respectively. Membrane electrode assemblies 16, each having an anode, membrane and cathode, are connected in series and separated from one another by bipolar collector plates 18. The stack is held together by a compression means, shown in FIG. 1 as a plurality of tie rods 26. Gaskets are used throughout the stack, as necessary, to seal and/or separate the various components.

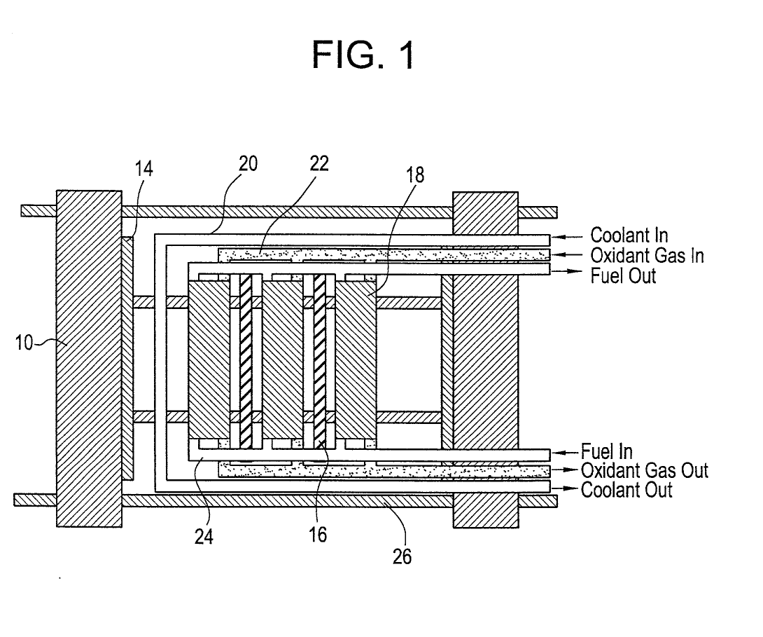

FIG. 2 is a plot comparing the flexural creep of polyphenylene sulfide compositions containing long glass fiber (40 and 50 weight percent loadings) with conventional short glass fiber (40 weight percent loading).

### DETAILED DESCRIPTION OF THE INVENTION

The thermoplastic resin composite used in the practice of this invention is a long fiber reinforced composite. As used herein, the term “long fiber reinforced composite” refers to composite materials produced by pultrusion or other techniques that imbed a relatively high loading, i.e., at least about 30 weight percent, of long strand fibers in the polymer matrix. Such processes are described, for example, in U.S. Patent No. Re. 32,772; U.S. Pat. No. 6,039,319; U.S. Pat. No. 5,236,781; and U.S. Pat. No. 5,679,456. In pultrusion processes, continuous rovings of reinforcing fiber are drawn through molten polymer in a manner that coats or impregnates the individual fiber strands with molten polymer and passed through a die that defines the diameter of the resulting pellet or rods. The coated rovings are then cooled and cut to a desired length. Pultrusion processes provide pellets or rods wherein the fibers are oriented in a substantially parallel alignment relative to the longitudinal axis thereof.

For purposes of this invention, the use of composites wherein the long strand glass fiber is at least about 5 mm, preferably from about 5 mm to about 20 mm, in length is desired. The use of composites wherein the long strand glass fiber is from about 5 mm to about 15 mm in length is oftentimes of particular interest. In the subject composites, the diameter of such fiber is typically about 10 micron to about 25 micron. Composites wherein the diameter of such fiber is from about 15 micron to 20 micron are of particular interest. In molded endplates, long glass fiber reinforced composites offer advantages over composites wherein the fiber reinforcement is conventional short glass fiber, in terms of the ability of the endplate being able to maintain its stiffness under load.

Composites having fiber contents of at least about 30 weight percent and, more particularly, from about 40 to about 60 weight percent, are of interest in the practice of this invention. At fiber contents of less than about 30 weight percent, the composites generally lack the strength and dimensional stability required for the subject application. For many endplate applications, the use of composites having fiber contents of about 50 weight percent or more is preferred, as this higher loading of long fiber generally results in higher creep resistance and increased dimensional stability in the resulting article. At fiber loadings in excess of about 70 weight percent, the composites generally lack sufficient resin to wet out the fiber and are more difficult to manufacture.

Materials suitable for use as the thermoplastic resin component (a) of subject composites should be capable of withstanding the temperature of the fuel cell stack. The use temperature of the stack is determined, in part, by the choice of membrane in the membrane electrode assemblies (MEAs) used therein. For example, stacks wherein the MEAs contain sulfonated fluropolymer membranes typically operate at temperatures of 60° C.-80° C., whereas, stacks wherein the MEAs contain PBI membranes typically operate at temperatures up to 160° C. or more. Desirably, the thermoplastic resin component is capable of being fabricated into molded parts at temperatures less than about 340° C. Higher melting resins may be used, however, such resins become more difficult to process in conventional injection molding equipment.

Exemplary of the materials useful as the thermoplastic resin component (a) are thermoplastic polymers such as partially aromatic polyamides, polyarylsulfones, polyaryletherketones, polyaryletheretherketones, polyaryletherimides, polyarylimides, polyarylene sulfide, aromatic thermotropic liquid crystal polymers, and the like. Lower temperature thermoplastics polymers may also be useful as the thermoplastic resin component (a) so long as the polymers are capable of forming composites that retain their stiffness, over time, under the use temperature and load requirements of the fuel cell stack. Desirably, the resins are flame resistant. It is also desirable that such resins are able to withstand the corrosive environment of materials with which they are in contact, for example, deionized water or other coolants. In many applications, resins comprising polyphenylene sulfide or aromatic thermotropic liquid crystal polymer are of particular interest as the thermoplastic resin component (a).

If desired, the subject composites may contain one or more additional optional components such as for example, colorants, lubricants, processing aids, stabilizers, and the like. Long fiber reinforced composites suitable for use in the practice of this invention are commercially available from a variety of sources including, for example, Ticona, Celstran, Inc.

For optimum performance of the stack, the endplate should not warp or bend upon molding or in use. The ability of a composite to maintain its shape when subjected to a constant force over time is a measure of its creep resistance. Thicker endplates may tolerate the use of a less creep resistant composite than thinner endplates. Thicker endplates, however, may add undesirably to the weight of a fuel stack and are undesirable from a material design perspective when space is an issue. Additionally, thicker endplates may be more difficult to mold. The use temperature of a particular application is also a factor in determining the creep resistance required of a particular endplate, as the creep resistance of a composite tends to vary with temperature.

The design and size of the endplates will depend upon the particular application. The endplate may comprise multiple parts or components, for example, supporting members, headers and the like. Utilizing the subject composites, it is often possible to eliminate metal supporting members from the endplate, and to fabricate the endplate as a single molded part. Additionally, in endplate assemblies comprising the subject endplates, it is often possible to eliminate separate compression plates and to use the endplates themselves as compression plates for the stack.

The endplates are formed by molding the thermoplastic resin composite using injection equipment and processing techniques such as are conventionally employed when molding long fiber reinforced thermoplastic composites. Such techniques include, for example, injection molding and compression molding. Desirably, the subject composites are molded using an injection molding machine equipped with a metering screw having a diameter of more than 40 mm, a compression ratio of 1:1.8 to 1:2.5 and an L/D value of 18:1 to 22:1. The metering screw is preferably a three-zone screw having separate metering, compression and feed zones, wherein the functional zone ratios are as follows:

feed—50 to 60%

compression 20 to 30%

metering 20%

Desirably, the flight depth of the feed zone is at least 4.5 mm.

Molding conditions may vary depending upon the composition of the composite, however, it is desirable to utilize conditions which minimize fiber length reduction during processing, for example, low screw speeds and low back pressure.

For many endplate applications the use of composites having a calculated creep resistance of less than 2.0 preferably less than 1.6 is desired. Throughout the subject specification and claims, the term “calculated creep resistance” means the % strain at 200 hours/% strain at 0.1 hour of a ⅛ in.×½ in.×5 in. test specimen measured at 140° C. and 10,000 psi using the test method of ASTM D2990-95.

In an embodiment of particular interest, the subject invention relates to an injection molded fuel cell endplate fabricated from a pultruded long fiber reinforced thermoplastic resin composite which composite comprises:

a) polyphenylene sulfide; and

b) from about 45 to about 55 weight percent of long strand glass fiber, wherein the long strand glass fiber is from about 10 mm to about 15 mm in length and from about 15 micron to about 20 micron in diameter.

### EXAMPLES

The following examples are presented to further illustrate this invention. The examples are not, however, intended to limit the invention in any way. Unless otherwise indicated, all parts and percentages are by weight, based on the total composite weight.

The composites used in these examples were as follows:

Sample 1—A pultruded polyphenylene sulfide composite containing 50 weight percent of long glass fiber 11 mm in length and 17 micron in diameter and 50 weight percent of polyphenylene sulfide having a melt viscosity of 500 poise.

Sample 2—A pultruded polyphenylene sulfide composite containing 40 weight percent of long glass fiber 11 mm in length and 17 micron in diameter and 60 weight percent of polyphenylene sulfide having a melt viscosity of 500 poise; and

Sample 3—A polyphenylene sulfide resin composite prepared by melt compounding 40.0 weight percent of glass fiber 1 mm in length and 13 micron in diameter with 59.2 weight percent of polyphenylene sulfide having a melt viscosity of 500 poise and 0.8 weight percent of processing additive.

Samples 1 to 3 were injection molded on a 100 ton molding machine with a gp screw into ASTM test specimens (for measuring flexural creep) and ISO test specimens (for measuring notched charpy impact). Prior to molding the Samples were dried for 4 hours at 130° C. Conditions during molding were as follows:

| | |
|---|---|
| melt temperature: | 320° C.; |
| mold temperature: | 150° C.; |
| cycle time: | 40 sec; and |
| screw speed: | 40 rpm. |

Flexural creep of the molded Samples was measured pursuant to ASTM test method D2990-95, at 10,000 psi and 140° C. Flexural creep data is provided in Table 1.

TABLE 1

| | SAMPLE 1 | SAMPLE 2 | SAMPLE 3 |
|---|---|---|---|
| HOURS | % STRAIN | | |
| 0.1 | 0.71 | 0.76 | 0.86 |
| 1 | 0.88 | 1.10 | 1.45 |
| 2 | 0.95 | 1.14 | 1.58 |
| 5 | 0.96 | 1.18 | 1.66 |
| 20 | 1.01 | 1.24 | 1.78 |
| 50 | 1.02 | 1.26 | 1.82 |
| 100 | 1.04 | 1.28 | 1.87 |
| 200 | 1.05 | 1.31 | 1.91 |

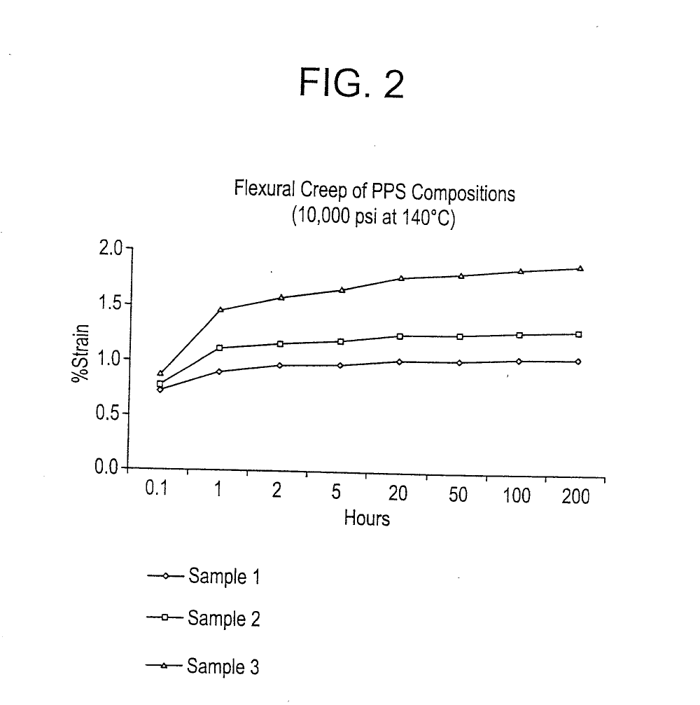

A plot of the flexural creep data of the molded Samples (% strain vs. time) is provided in FIG. 2. As illustrated by the data, the flexural creep resistance of Sample 1 (which contained 50 weight percent of long glass fiber) and Sample 2 (which contained 40 weight percent of long glass fiber) were significantly higher than that of Sample 3 (which contained 40 weight percent of a conventional short glass fiber). Endplates fabricated from Samples 1 or 2 are expected to have greater dimensional stability and resistance to warpage under load than endplates fabricated from Sample 3.

Notched charpy impact of the molded Samples was measured pursuant to the test procedure of ISO 179 at 23° C., 100° C., and 150° C. Notched charpy impact data is provided in Table 2.

TABLE 2

| | NOTCHED CHARPY IMPACT (kJ/m²) | | |
|---|---|---|---|
| TEST TEMPERATURE | 23° C. | 100° C. | 150° C. |
| Sample 1 | 22.6 | 20.1 | 23.0 |
| Sample 2 | 18.3 | 17.6 | 23.4 |
| Sample 3 | 9.2 | 10.7 | 15.1 |

As illustrated by the data, the notched charpy impact of Samples 1 and 2 is significantly higher than that of Sample 3. Endplates fabricated from Samples 1 and 2 are expected to better withstand the concentration of force on tie rod holes or other notches or apertures in the part, than endplates fabricated from Sample 3.

What is claimed is:

1. A molded fuel cell end plate fabricated from a long fiber reinforced thermoplastic resin composite, which composite comprises:
(a) a thermoplastic resin; and
(b) at least about 30 weight percent of long strand glass fiber at least about 5 mm in length.

2. A fuel cell endplate as described in claim 1 wherein the diameter of the long strand glass fiber is from about 10 micron to about 25 micron.

3. A fuel cell endplate as described in claim 2 wherein said composite contains from about 40 to about 60 weight percent of said long strand glass fiber.

4. A fuel cell endplate as described in claim 2 wherein said long strand glass fiber is from about 5 mm to about 20 mm in length.

5. A fuel cell endplate as described in claim 3 wherein said thermoplastic resin component (a) comprises a thermoplastic polymer selected from the group consisting of partially aromatic polyamides, polyarylsulfones, polyaryletherketones, polyaryletheretherketones, polyaryletherimides, polyarylimides, polyarylene sulfide, aromatic thermotropic liquid crystal polymers, and the like.

6. A fuel cell endplate as described in claim 5 wherein said long strand glass fiber is from about 15 micron to about 20 micron in diamater.

7. A fuel cell endplate as described in claim 6 wherein said thermoplastic resin component (a) comprises polyarylene sulfide or aromatic thermotropic liquid crystal polymer.

8. A fuel cell endplate as described in claim 5 wherein said composite contains at least about 50 weight percent of said long strand glass fiber.

9. A fuel cell endplate as described in claim 8 wherein said thermoplastic resin component (a) comprises polyphenylene sulfide.

10. A fuel cell endplate as described in claim 6 wherein said long strand glass fiber is incorporated in said composite by pultrusion techniques.

11. A fuel cell end plate as described in claim 2 which is fabricated as a single injection molded part.

12. A fuel cell endplate as described in claim 2 wherein said composite has a calculated creep resistance of less than 2.0.

13. A fuel cell endplate as described in claim 5 wherein said composite has a calculated resistance of less than 1.6.

14. An injection molded fuel cell endplate fabricated from a pultruded long fiber reinforced thermoplastic resin composite which composite comprises:
a) polyphenylene sulfide; and
b) about 45 to about 55 weight percent of long strand glass fiber, wherein the long strand glass fiber is from about 10 mm to about 15 mm in length and from about 15 micron to about 20 micron in diameter.

15. A fuel cell endplate assembly comprising a fuel cell endplate as described in claim 1.

16. A fuel cell endplate assembly comprising a fuel cell end plate as described in claim 5.

17. A fuel cell endplate assembly as described in claim 16 wherein the end plate functions as a compression plate.

18. A fuel cell endplate assembly as described in claim 17 which lacks a separate compression plate.
